(19) United States
(12) Patent Application Publication
(10) Pub. No.: US 2025/0145872 A1
(43) Pub. Date: May 8, 2025

(54) ADHESIVE COMPOSITION

(71) Applicant: TOYOBO CO., LTD., Osaka (JP)

(72) Inventor: Takuya SHIBA, Shiga (JP)

(73) Assignee: TOYOBO CO., LTD., Osaka (JP)

(21) Appl. No.: 18/838,075

(22) PCT Filed: Feb. 14, 2023
(86) PCT No.: PCT/JP2023/004994

§ 371 Date: Aug. 13, 2024

(30) Foreign Application Priority Data
Feb. 17, 2022 (JP) 2022-022833

(51) Int. Cl. C09J 163/00; C09J 11/04; C09J 11/08

(52) U.S. Cl. CPC C09J 163/00; C09J 11/04; C09J 11/08

(57) ABSTRACT

An object of the present invention is to provide an epoxy-based adhesive having excellent toughness and heat resistance as well as excellent adhesiveness to a substrate. The adhesive composition according to the present invention can suitably be used as an adhesive excellent in adhesiveness, toughness, and heat resistance, is therefore expected to greatly contribute to industry, especially in the field of structural adhesives. An adhesive composition containing an epoxy resin (A), a curing agent (B), a curing catalyst (C), a thixotropic agent (D), and a crystalline polyester (E).

### TECHNICAL FIELD

The present invention relates to an adhesive composition. Specifically, the present invention relates to an epoxy-based adhesive excellent in adhesiveness, toughness, and heat resistance and a laminated body and a vehicle using the same.

### BACKGROUND ART

Epoxy-based adhesives are excellent in

characteristics such as mechanical properties, water resistance, chemical resistance, and heat resistance. For this reason, epoxy-based adhesives are conventionally used in a wide range of fields such as paints, molding materials, thermal interface materials, and adhesives, and are therefore essential materials for industry.

An epoxy-based adhesive is usually a thermosetting resin containing an epoxy resin, a curing agent, and a catalyst. By heating the epoxy-based adhesive, oxirane rings are reacted with the curing agent so that a cured body is formed by polyaddition. It is known that such a thermosetting resin is superior in mechanical properties, corrosion resistance, and adhesiveness, compared with various materials. For such characteristics, epoxy-based adhesives are widely used for bonding structures of vehicles such as automobiles and railway trains and aircrafts. Such adhesives are called structural adhesives.

On the other hand, epoxy-based adhesives are brittle, and therefore addition of modifiers and control of cross-linking densities of cured bodies have widely been studied. For example, Patent Document 1 discloses that a flexible chain is introduced into a resulting cured body by adding CTBN (carboxyl group-containing butadiene-acrylonitrile liquid rubber) so as to improve toughness.

### PRIOR ART DOCUMENT

### Patent Document

Patent Document 1: Japanese Patent Application Laid-Open (JP-A) No. 148337/93

### DISCLOSURE OF THE INVENTION

### Problem that the Invention is to Solve

Such a method disclosed in Patent Document 1, in which a flexible chain is introduced, makes it possible to improve toughness but has a problem that heat resistance is reduced. It is therefore an object of the present invention to provide an epoxy-based adhesive having excellent toughness and heat resistance as well as excellent adhesiveness to a substrate.

### Means for Solving the Problem

In light of the problem of such a conventional technique, the present invention has been accomplished. The present inventors have intensively studied and, as a result, have found that the object of the present invention can be achieved by the following means, which has led to the completion of the present invention.

Specifically, the present invention includes the following configurations.
[1] An adhesive composition containing an epoxy resin (A), a curing agent (B), a curing catalyst (C), a thixotropic agent (D), and a crystalline polyester (E).
[2] The adhesive composition according to the above [1], wherein the crystalline polyester (E) has an ether bond-containing polyol as a copolymerization component.
[3] The adhesive composition according to the above [1] or [2], wherein the crystalline polyester (E) has a melting point of 20° C. or higher.
[4] The adhesive composition according to any one of the above [1] to [3], wherein the adhesive composition further contains inorganic particles (F) having moisture absorbency.
[5] The adhesive composition according to any one of the above [1] to [4], wherein the crystalline polyester (E) is contained in an amount of 1 to 60 parts by mass per 100 parts by mass of the epoxy resin (A).
[6] A laminated body having an adhesive layer obtained by curing the adhesive composition according to any one of the above [1] to [5].
[7] A vehicle having the laminated body according to the above [6].

### Effects of the Invention

The present invention makes it possible to provide an adhesive composition having excellent toughness and heat resistance as well as excellent adhesiveness to a substrate. Therefore, the adhesive composition according to the present invention can suitably be used as structural adhesive.

### MODE FOR CARRYING OUT THE INVENTION

Hereinafter, the present invention will be described in detail. The adhesive composition according to the present invention contains an epoxy resin (A), a curing agent (B), a curing catalyst (C), a thixotropic agent (D), and a crystalline polyester (E) as essential components.

### Epoxy Resin (A)

The epoxy resin (A) used for the adhesive composition according to the present invention is not limited as long as it is an epoxy compound having two or more oxirane rings. Examples of the epoxy resin (A) used in the present invention include: a bisphenol-type epoxy resin obtained by glycidyl-etherifying a bisphenol compound such as bisphenol A, bisphenol F, bisphenol AP, bisphenol AF, bisphenol B, bisphenol BP, bisphenol C, bisphenol E, bisphenol M, bisphenol S, bisphenol P, bisphenol PH, or bisphenol Z; a monocyclic aromatic glycidyl ether compound obtained by glycidyl-etherifying a polyhydric aromatic alcohol such as catechol, resorcinol, or hydroquinone; a polycyclic aromatic epoxy resin obtained by glycidyl-etherifying a polycyclic aromatic compound such as naphthalene, biphenyl, tetramethylbiphenyl, bisphenol fluorene, biscresol fluorene, or tetraphenylol ethane; a novolac-type epoxy resin obtained by epoxidizing a novolac-type compound such as phenol novolac, cresol novolac, or bisphenol A novolac; a glycidyl amine-type epoxy resin obtained by glycidyl-etherifying an aromatic amino compound such as aniline, o-methylaniline, p-aminophenol, or m-phenylenediamine; a polyfunctional epoxy resin such as triglycidyl isocyanurate, a triphenyl glycidyl ether methane-type epoxy resin, a xylylene-type epoxy resin, a tetrakisphenolethane-type epoxy resin, or a naphthalene-type epoxy resin; an alkylene oxide glycidyl compound obtained by glycidylating an alkylene oxide adduct such as an ethylene oxide adduct of bisphenol A or a propylene oxide adduct of bisphenol A; an aliphatic glycidyl compound obtained by glycidylating an aliphatic polyhydric alcohol such as 1,4-butanediol, 1,6-hexanediol, 1,12-dodecanediol, cyclohexanedimethanol, 2,2-dimethylpropanediol, trimethylolpropane, dicyclopentadiene dimethanol, hydrogenated bisphenol A, polybutadienediol, sorbitol, pentaerythritol, or polyglycerol; an n aliphatic glycidyl ester compound obtained by glycidylating an aliphatic polyvalent carboxylic acid such dimer acid, as hexahydrophthalic acid, or hexahydroterephthalic acid; an epoxy compound obtained by epoxidizing an unsaturated group-containing compound such as polybutadiene or polyisoprene; and a mixture obtained by partial condensation of the above compound. Among these, from the viewpoint of mechanical properties, a bisphenol-type epoxy resin is preferred, and a bisphenol A-type epoxy resin and a bisphenol F-type epoxy resin are particularly preferred.

### Curing Agent (B)

The curing agent (B) used for the adhesive composition according to the present invention is not limited as long as it reacts with the epoxy resin (A), and specific examples thereof include: dicyandiamide; hydrazides such as adipic acid dihydrazide, isophthalic acid dihydrazide, and dibasic acid dihydrazide; bisphenolic compounds such as bisphenol A, bisphenol F, and bisphenol E; catecholic compounds such as catechol, resorcinol, and methylcatechol; biphenolic compounds such as biphenol and tetramethylbiphenol; biscresolic compounds such as biscresolfluorene; hydroquinone compounds such as hydroquinone; liquefied phenolic compounds such as tris(dimethylaminomethyl)phenol; novolac compounds such as phenol novolac, cresol novolac, bisphenol A novolac, xylylene novolac, triphenylmethane novolac, biphenyl novolac, dicyclopentadiene phenol novolac, and terpene phenol novolac; aliphatic amines such as diethylene triamine, triethylene tetramine, tetraethylene pentamine, trimethyl hexamethylene diamine, 2-methylpentamethylenediamine, and diethylaminopropylamine; alicyclic polyamines such as isophoronediamine, 1,3-bisaminomethylcyclohexane, bis(4-aminocyclohexyl)methane, norbornenediamine, 1,2-diaminocyclohexane, and 4,4′-methylenebis(2-methylcyclohexaneamine); polyether-type polyamines such as polyoxypropylenediamine and polyoxypropylenetriamine; polycyclohexylpolyamine mixtures; piperazines such as piperazine and N-aminoethylpiperazine; polyaminoamides such as semicarbazide and cyanoacetamide; polyamideamines obtained by condensation of dimer acid or fatty acid with polyamines; Michael addition polyamines obtained by reaction between amines and acrylic compounds; Mannich reaction products; ketimines; melamines; guanamines such as acetoguanamine and benzoguanamine; guanidines; aromatic amines such as 4,4′-diaminodiphenylmethane, 4,4′-diaminodiphenylsulfone, meta-phenylenediamine, and m-xylenediamine; acid anhydrides such as tetrahydrophthalic anhydride, hexahydrophthalic anhydride, methyltetrahydrophthalic anhydride, methylhexahydrophthalic anhydride, benzophenonetetracarboxylic anhydride, pyromellitic anhydride, trimellitic anhydride, methylnadic anhydride, hydrogenated methylnadic anhydride, dodecenylsuccinic anhydride, succinic anhydride, phthalic anhydride, aliphatic dibasic acid polyanhydride, and ethyleneglycol bisanhydrotrimellitate; and boron trifluoride complex compounds, boron trichloride complex compounds, sulfonium salts, onium salts, and active esters of polyvalent carboxylic acids. Among these, dicyandiamide is preferred from the viewpoint of latency, and phenol novolacs and bisphenolic compounds are preferred from the viewpoint of toughness and heat resistance. Particularly preferred are dicyandiamide, bisphenol A, and bisphenol F.

An appropriate content of the curing agent (B) in the adhesive composition according to the present invention depends on the type of curing agent used. In the case of a curing agent that has catalytic activity for the epoxy resin (A), such as dicyandiamide, the content of the curing agent (B) is preferably 1 to 15 parts by mass and more preferably 3 to 10 parts by mass per 100 parts by mass of the epoxy resin (A). When the content is within the above range, curability and cross-linkability are exhibited so that excellent toughness is achieved. On the other hand, in the case of a curing agent that has poor catalytic activity for the epoxy resin (A), such as a bisphenol, the curing agent (B) is preferably contained in an amount such that a ratio of the active hydrogen value of the curing agent (B) to the epoxy value of the epoxy resin (A) is in the range of 0.9 to 1.1 from the viewpoint of curability. The above ratio is more preferred to be in the range of 1.0 to 1.1 and further preferred to be in the range of 1.05 to 1.1. This is because when epoxy groups are in excess over active hydrogen groups, a branch-forming reaction occurs so that the heat resistance of a cured product is further improved.

### Curing Catalyst (C)

The curing catalyst (C) used for the adhesive composition according to the present invention is not limited as long as it can promote the reaction between the resin (A) and the curing agent (B). Specific examples of the curing catalyst (C) include: ureas such as 3-(4-chlorophenyl)-1,1-dimethylurea, 3-(3,4-dichlorophenyl)-1,1-dimethylurea, N,N′-(4-methyl-1,3-phenylene)bis[N,N′-dimethylurea], and N′-[3-[[[(dimethylamino)carbonyl]amino]methyl]-3,5,5-trimethylcyclohexyl]-N,N-dimethylurea; DBU-type amines such as DBU (1,8-diazabicyclo[5.4.0]undec-7-ene), DBU-phenol salt, DBU-octylic acid salt, DBU-formic acid salt, and DBU-p-toluenesulfonic acid salt; DBN (1,5-diazabicyclo[4.3.0]none-5-ene); tertiary amines such as triethylamine, N,N,N′,N′-tetramethylethylenediamine, tetramethylguanidine, and triethylenediamine; alcohol amines such as dimethylaminomethanol and dimethylaminoethanol; ether amines such as bis(2-dimethylaminoethyl) ether; phenol group-containing tertiary amines such as 2,4,6-tris(dimethylaminomethyl)phenol (DMP-30); amine adducts; imidazoles such as 1,2-dimethylimidazole, 2-ethyl-4-methylimidazole, 2-phenylimidazole, 2-phenyl-4-methylimidazole, N-benzyl-2-methylimidazole, N-benzyl-2-phenylimidazole, 2,4-dimethylimidazole, imidazole, 1-methylimidazole, 2-methylimidazole, 2,4-diamino-6-[2′-methylimidazolyl-(1′)]-ethyl-s-triazine isocyanulic acid adduct, 2-phenyl-4,5-dihydroxymethylimidazole, 2,4-diamino-6-[2′-methylimidazolyl-(1′)]-ethyl-s-triazine, and 1-cyanoethyl-2-phenylimidazolium trimellitate; imidazole adducts such as AJICURE PN-23, PN-23J, PN-H, PN-31, PN-31J, PN-40, PN-40J, and PN-50 (all of which are manufactured by Ajinomoto Fine-Techno Co., Inc.) and NOVACURE HX-3722, HX-3742, and HX-3792 (all of which are manufactured by Asahi Kasei Corp.); and phosphoruses such as triphenylphosphine, tri-o-tolylphosphine, tri-m-tolylphosphine, tri-p-tolylphosphine, tri-2,4-xylylphosphine, tri-2,5-xylylphosphine, tri-3,5-xylylphosphine, tris(p-methoxyphenyl)phosphine, tris(o-methoxyphenyl)phosphine, triphenylphosphine triphenylborane, tetraphenylphosphonium tetraphenylborate, tetraphenylphosphonium tetra-p-tolylborate, and tris(2,6-dimethoxyphenyl)phosphine. Among these curing catalysts, from the viewpoint of curability and latency, ureas, imidazole adducts, and phosphoruses are preferred.

From the viewpoint of activity and stability during curing, the content of the curing catalyst (C) in the adhesive composition according to the present invention is preferably 0.5 to 20 parts by mass, more preferably 0.5 to 10 parts by mass, and further preferably 0.5 to 8 parts by mass, per 100 parts by mass of the epoxy resin (A). When the content is within the above range, curability and stability are excellent from the viewpoint of catalyst activity and reaction speed.

### Thixotropic Agent (D)

The thixotropic agent (D) used in the present invention is not limited as long as it has the effect of imparting thixotropicity to the epoxy-based adhesive. Specific examples of the thixotropic agent (D) include: fumed silicas such as hydrophilic fumed silica and hydrophobic fumed silica; fine particles such as carbon black and various metallic powders; and inorganic fillers having a high aspect ratio such as wollastonite, mica, talc, kaolin, barium sulfate, calcium carbonate, magnesium hydroxide, and clay. Among these, from the viewpoint of achieving appropriate thixotropicity and the viewpoint of high hydrophobicity, hydrophobic fumed silica is preferred.

The content of the thixotropic agent (D) in the adhesive composition according to the present invention is preferably 0.5 to 20 parts by mass, more preferably 1 to 15 parts by mass, and further preferably 1 to 10 parts by mass, per 100 parts by mass of the epoxy resin (A). When the content is within the above range, the viscosity of the adhesive is kept in an appropriate range during application and curing, which is preferred in terms of excellent workability.

### Crystalline Polyester (E)

The adhesive composition according to the present invention contains a crystalline polyester (E). When containing a crystalline polyester (E), the adhesive composition can have high toughness and heat resistance. It is known that polyesters are excellent in solubility in epoxy resins, and amorphous polyesters are completely compatible with epoxy resins. Therefore, it is difficult for amorphous polyesters to improve the toughness of brittle epoxy resins. The present inventors have intensively studied and, as a result, have found that the use of a crystalline polyester improves toughness due to formation of a phase-separated structure caused by crystallization. Further, formation of a phase-separated structure prevents a reduction in heat resistance caused by compatibilization and improves the heat resistance of the adhesive composition. The term “crystalline” used herein means that a clear melting peak appears when the temperature is increased from −100°° C. to 250° C. at 20° C./min, using a differential scanning calorimeter (DSC).

The crystalline polyester (E) used for the adhesive composition according to the present invention is preferably one composed of a polycarboxylic acid component and a polyol component. The polycarboxylic acid component constituting the crystalline polyester (E) is preferably one containing 60 mol % or more of an aromatic dicarboxylic acid when the entire amount of the polycarboxylic acid component is taken as 100 mol %. The aromatic dicarboxylic acid contained therein is more preferably 70 mol % or more, further preferably 80 mol % or more, and may be 100 mol %. If the amount of the aromatic dicarboxylic acid is too small, an amorphous polyester may be obtained.

The aromatic dicarboxylic acid is not limited, and examples thereof include terephthalic acid, isophthalic acid, orthophthalic acid, naphthalenedicarboxylic acid, biphenyldicarboxylic acid, and diphenic acid. Other examples of the aromatic dicarboxylic acid include sulfonic acid group-containing aromatic dicarboxylic acids such as sulfoterephthalic acid, 5-sulfoisophthalic acid, 4-sulfophthalic acid, 4-sulfonaphthalene-2,7-dicarboxylic acid, and 5-(4-sulfophenoxy) isophthalic acid, and sulfonate salt group-containing aromatic dicarboxylic acids such as metal salts and ammonium salts of the sulfonic acid group-containing aromatic dicarboxylic acids. These may be used singly or in combination of two or more of them. Among these, from the viewpoint that the crystallizability of the polyester can be improved, terephthalic acid, isophthalic acid, naphthalenedicarboxylic acid, and a mixture of two or more of them are preferred. From the viewpoint that peel strength can be improved, naphthalene dicarboxylic acid is particularly preferred.

Examples of another polycarboxylic acid component include: alicyclic dicarboxylic acids such as 1, 4-cyclohexanedicarboxylic acid, 1,3-cyclohexanedicarboxylic acid, 1,2-cyclohexanedicarboxylic acid, and acid anhydrides thereof; and aliphatic dicarboxylic acids such as succinic acid, adipic acid, azelaic acid, sebacic acid, dodecanedioic acid, and dimer acid. Alternatively, an oxycarboxylic acid compound having a hydroxyl group and a carboxyl group in the molecular structure thereof may be used, and examples thereof include 5-hydroxyisophthalic acid, p-hydroxybenzoic acid, p-hydroxyphenethyl alcohol, p-hydroxyphenylpropionic acid, p-hydroxyphenylacetic acid, 6-hydroxy-2-naphthoic acid, and 4,4-bis(p-hydroxyphenyl)valeric acid.

The polyol component constituting the crystalline polyester (E) is preferably one containing 90 mol % or more of a glycol component when the entire amount of the polyol component is taken as 100 mol %. The glycol component contained therein is more preferably 95 mol % or more, and may be 100 mol %.

From the viewpoint that crystallizability can be improved, the glycol component preferably contains an aliphatic glycol. Examples of the aliphatic glycol include ethylene glycol, 1,2-propylene glycol, 1,3-propanediol, 1,4-butanediol, 2-methyl-1,3-propanediol, 1,5-pentanediol, 2,2-dimethyl-1,3-propanediol, 1,6-hexanediol, 3-methyl-1,5-pentanediol, 1,9-nonanediol, 2-ethyl-2-butylpropanediol (DMH), and 2,2,4-trimethyl-1,3-pentanediol. These may be used singly or in combination of two or more of them. Among these, from the viewpoint that crystallizability can further be improved, linear glycols having no branched chain are more preferred, and ethylene glycol, 1,3-propanediol, 1,4-butanediol, and 1,6-hexanediol are particularly preferred. When the entire amount of the polyol component constituting the crystalline polyester (E) is taken as 100 mol %, 40 mol % or more of the aliphatic glycol is preferably contained and 50 mol % or more of the aliphatic glycol is more preferably contained.

As to the glycol component constituting the crystalline polyester (E), an ether bond-containing polyol component is also preferably contained. When the ether bond-containing polyol is contained, flexibility is imparted to the crystalline polyester (E), which improves the tensile shear strength and T-peel strength of the adhesive composition according to the present invention. Specific examples of the ether bond-containing polyol include: alkylene glycols such as diethylene glycol, triethylene glycol, and dipropylene glycol; polyalkylene glycols such as polyethylene glycol, polypropylene glycol, and polytetramethylene glycol; and alkylene oxide adducts of alkylene glycols such as an ethylene oxide adduct of neopentyl glycol and a propylene oxide adduct of neopentyl glycol. These may be used singly or in combination of two or more of them. From the viewpoint that flexibility can further be imparted, the average molecular weight of the ether bond-containing polyol is preferably 300 or more, more preferably 500 or more, and further preferably 800 or more. The average molecular weight of the ether bond-containing polyol is preferably 5000 or less and more preferably 3000 or less. When the entire amount of the polyol component constituting the crystalline polyester (E) is taken as 100 mol %, 5 mol % or more of the ether bond-containing polyol is preferably contained and 10 mol % or more of the ether bond-containing polyol is more preferably contained. Further, from the viewpoint of maintaining the crystallizability of the crystalline polyester (E), the amount of the ether bond-containing polyol is preferably 60 mol % or less and more preferably 50 mol % or less.

As to a glycol component other than the above constituting the crystalline polyester (E), an alicyclic glycol, an aromatic ring-containing glycol, or the like may be contained. Examples of the alicyclic glycol include 1,4-cyclohexanediol, 1,4-cyclohexanedimethanol, tricyclodecanediol, tricyclodecanedimethylol, spiroglycol, hydrogenated bisphenol A, an ethylene oxide adduct and a propylene oxide adduct of hydrogenated bisphenol A. Examples of the aromatic ring-containing glycol include p-xylene glycol, m-xylene glycol, o-xylene glycol, hydroquinone, an ethylene oxide adduct and a propylene oxide adduct of hydroquinone, bisphenol A, and glycols obtained by adding one to several moles of ethylene oxide or propylene oxide to two phenolic hydroxyl groups of bisphenols, such as an ethylene oxide adduct and a propylene oxide adduct of bisphenol A. These may be used singly or in combination of two or more of them.

If necessary, the polycarboxylic acid component and/or the polyol component may be copolymerized with a tri- or higher-functional component for the purpose of introducing a branched skeleton into the crystalline polyester (E). When the polycarboxylic acid component and/or the polyol component are/is copolymerized with a tri- or higher-functional component, the amount of the tri- or higher-functional component is preferably 0.1 mol % or more and 5 mol % or less, and more preferably 0.5 mol % or more and 3 mol % or less when the entire amount of each of the polycarboxylic acid component and the polyol component is taken as 100 mol %. When the amount of the tri- or higher-functional component is within the above range, a branched skeleton can be introduced so that the terminal group concentration of the resin is increased and terminal groups can be used for improvement of adhesiveness and for a curing reaction. On the other hand, if the amount of the tri- or higher-functional component exceeds 5 mol %, gelation may occur during polymerization.

Examples of the tri- or higher-functional polycarboxylic acid component include compounds such as trimellitic acid, trimesic acid, ethylene glycol bis(anhydrotrimellitate), glycerol tris(anhydrotrimellitate), trimellitic anhydride, pyromellitic anhydride (PMDA), oxydiphthalic dianhydride (ODPA), 3,3′,4,4′-benzophenonetetracarboxylic dianhydride (BTDA), 3,3′,4,4′-diphenyltetracarboxylic dianhydride (BPDA), 3,3′,4,4′-diphenylsulfonetetracarboxylic dianhydride (DSDA), 4,4′-(hexafluoroisopropylidene)diphthalic dianhydride (6FDA), and 2,2′-bis[(dicarboxyphenoxy)phenyl]propane dianhydride (BSAA). Examples of the tri- or higher-functional polyol include glycerin, trimethylol ethane, trimethylol propane, and pentaerythritol.

The acid value of the crystalline polyester (E) is preferably 10 mgKOH/g or less and more preferably 5 mgKOH/g or less. The lower limit of the acid value is not limited and is, for example, 1 mgKOH/g or more. When the acid value of the crystalline polyester (E) is within the above range, compatibility with the epoxy resin (A) is adjusted so that the adhesive composition has excellent heat resistance and toughness.

The melting point of the crystalline polyester (E) is preferably 20° C. or higher, more preferably 50° C. or higher, further preferably 80° C. or higher, and furthermore preferably 100° C. or higher. The melting point is preferably 250° C. or lower and more preferably 230° C. or lower. When the melting point is equal to or higher than the above lower limit, the phase-separated structure between the epoxy resin (A) and the crystalline polyester (E) in the adhesive composition is well maintained so that the toughness and heat resistance of the adhesive composition can be improved. When the melting point is equal to or lower than the above upper limit, the adhesive composition has appropriate flowability so that excellent workability is achieved.

The glass transition temperature of the crystalline polyester (E) is preferably 0° C. or lower, more preferably −20° C. or lower, and further preferably −40° C. or lower. When the glass transition temperature is equal to or lower than the above upper limit, embrittlement of the crystalline polyester in a service temperature range is prevented so that excellent toughness is maintained.

The number average molecular weight of the crystalline polyester (E) is not limited and is preferably 2000 or more, more preferably 5000 or more, and further preferably 10000 or more. The number average molecular weight is preferably 100000 or less, more preferably 50000 or less, and further preferably 45000 or less. When the number average molecular weight of the crystalline polyester (E) is within the above range, the adhesive composition has excellent flexibility and toughness.

In the adhesive composition according to the present invention, the crystalline polyester (E) is preferably dispersed in the epoxy resin (A). A dispersion method is not limited, and the crystalline polyester (E) can be dispersed in the epoxy resin (A) by dispersing, with the use of a kneader or a planetary mixer, the crystalline polyester (E) which has been mechanically pulverized or an emulsion of the crystalline polyester (E) which has been solidified by spray drying. Alternatively, the crystalline polyester (E) can be dispersed finely and evenly in the epoxy resin (A) by dissolving the crystalline polyester (E) in the heated epoxy resin (A) and then depositing the crystalline polyester (E) by cooling.

The content of the crystalline polyester (E) in the adhesive composition according to the present invention is preferably 1 to 60 parts by mass, more preferably 1 to 50 parts by mass, and further preferably 3 to 30 parts by mass, per 100 parts by mass of the epoxy resin (A). When the content is within the above range, higher toughness can be achieved while a reduction in heat resistance is prevented.

### Inorganic Particles (F) Having Moisture Absorbency

The adhesive composition according to the present invention may further contain inorganic particles (F) having moisture absorbency. When the inorganic particles (F) having moisture absorbency are contained, moisture contained in the composition is trapped so that foaming during curing can be prevented. An appropriate example of the inorganic particles (F) having moisture absorbency includes calcium oxide particles. Such calcium oxide particles are not limited by whether they have been surface-treated or not or by their particle diameter as long as calcium oxide is mainly contained.

The content of the inorganic particles (F) having moisture absorbency in the adhesive composition according to the present invention is preferably 0.5 to 10 parts by mass, more preferably 1 to 10 parts by mass, and further preferably 3 to 10 parts by mass, per 100 parts by mass of the epoxy resin (A). When the content is within the above range, it can be expected that foaming during curing will be prevented, and a resulting cured product has excellent toughness.

### Other Components

The adhesive composition according to the present invention contains an epoxy resin (A), a curing agent (B), a curing catalyst (C), a thixotropic agent (D), and a crystalline polyester (E), and may further contain calcium oxide (F). In addition to them, an elastomer, a core-shell rubber, a coupling agent, an inorganic filler, a spacer, and various additives may further be contained.

The adhesive composition according to the present invention may contain an elastomer, which may have the effect of improving peel strength and impact strength. Examples of the elastomer include: rubber-modified epoxy resins such as NBR (acrylonitrile-butadiene rubber), SBR (styrene-butadiene rubber), polybutadiene, and carboxylic acid-terminated acrylonitrile butadiene; ADEKA RESIN EPR series (manufactured by ADEKA CORPORATION) and Hypox series such as Hypox RA840 and RA1340 (manufactured by CVC); urethane-modified epoxy resins having a urethane bond and two or more oxirane rings in the molecule; ADEKA RESIN EPR series such as ADEKA RESIN EPR 1630 and Hypox series such as Hypox UA10 (manufactured by CVC), which are not limited as long as they have the above composition; liquid rubbers such as NBR, SBR, and polybutadiene; silicone resins; cross-linked rubber fine particles such as cross-linked NBR and cross-linked BR; urethane rubber; carboxylic acid-terminated or amino-terminated acrylonitrile-butadiene rubber (CTBN, ATBN); NBR rubber having a carboxylic acid in the main chain; carboxylic acid-terminated polybutadiene; liquid polysulfide; various urethane prepolymers; and fine particles of engineering plastic resins such as polyether sulfone and polyamide, polyether imide, acrylic, polyester, and polycarbonate. These may be used singly or in combination of two or more of them.

The adhesive composition according to the

present invention may contain core-shell rubber, which may have the effect of improving peel strength and impact strength. Examples of the core-shell rubber include KANE-ACE MX153, MX-154, MX-257, MX-960, MX-136, and MX-217 (all of which are manufactured by KANEKA CORPORATION) and GANZPEARL (manufactured by Aica Kogyo Company, Limited).

It should be noted that core-shell rubber refers to a particle having a structure of at least two layers: a core layer composed of a rubber component and a hard shell layer. For the core layer, a rubber-like material is used. The core layer is composed of, for example, a polymer obtained by polymerization of a conjugated diene such as polybutadiene and/or a lower alkyl acrylate, a polymer obtained by copolymerization with a monomer copolymerizable therewith, or polysiloxane rubber. The core layer is preferably composed of a material having a glass transition temperature of −20° C. or lower, from the viewpoint of improving impact resistance and improving peel strength at low temperature. The shell layer is preferably composed of a component that has a high affinity for the epoxy resin and does not exhibit rubber elasticity. The shell layer is not limited as long as it is composed of such a component, but is preferably composed of a polymer obtained by polymerization of a methyl methacrylate monomer and/or a styrene monomer or a polymer obtained by copolymerization with a monomer copolymerizable therewith, from the viewpoint of graft polymerizability and affinity for the epoxy resin. The shell layer is preferably composed of a material having a glass transition point of 50° C. or higher, from the viewpoint of adhesiveness.

The adhesive composition according to the present invention may contain a coupling agent, which may have the effect of improving shear strength and peel strength due to improvement in interface strength. Examples of the coupling agent include silane coupling agents such as vinyltrimethoxysilane, vinyltriethoxysilane, 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, p-styryltrimethoxysilane, 3-methacryloxypropylmethyldimethoxysilane, 3-methacryloxypropyltrimethoxysilane, 3-methacryloxypropylmethyldiethoxysilane, 3-methacryloxypropyltriethoxysilane, 3-acryloxypropyltrimethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethyl-butylidene)propylamine, N-phenyl-3-aminopropyltrimethoxysilane, tris-(trimethoxysilylpropyl)isocyanurate, 3-mercaptopropylmethyldimethoxysilane, 3-mercaptopropyltrimethoxysilane, 3-isocyanatepropyltriethoxysilane, and 3-trimethoxysilylpropyl succinic anhydride.

The adhesive composition according to the present invention may contain an inorganic filler, which may have the effect of improving mechanical strength and imparting thixotropicity. Examples of the inorganic filler include wollastonite, mica, talc, kaolin, barium sulfate, calcium carbonate, magnesium hydroxide, clay, calcium silicate, aluminum silicate, calcium hydroxide, magnesium hydroxide, aluminum hydroxide, magnesium carbonate, barium carbonate, syenite, chlorite, bentonite, montmorillonite, barite, dolomite, quartz, glass, feldspar, diatomaceous earth, mica, kaolin, alumina, graphite, fibers such as carbon fibers and glass fibers, silicas such as crystalline silica, amorphous silica, molten silica, fumed silica, calcined silica, precipitated silica, and pulverized (micronized) silica, iron oxide, zinc oxide, titanium oxide, barium oxide, titanium dioxide, hollow glass beads, and polymer hollow beads. These may be used singly or in combination of two or more of them.

The adhesive composition according to the present invention may contain a spacer, which may have the effect of adjusting thickness and improving temporary tackiness. Examples of the spacer include glass beads, fibers, resin beads, and inorganic fillers having a certain hardness or more and a certain particle diameter or more. These may be used singly or in combination of two or more of them.

The particle diameter of the spacer is preferably 1 to 200 μm and more preferably 10 to 150 μm. If the particle diameter of the spacer is less than 1 μm, it may be difficult to control the thickness of a bonded body, and if the particle diameter of the spacer exceeds 200 μm, the stress of a bonded body may be too large.

Examples of the shape of the spacer include a spherical particle and a fibrous particle. Among these, a spherical particle is preferred from the viewpoint of ease of particle diameter control.

When the spacer is used, the amount of the spacer used is preferably 0.2 to 1.5 parts by mass and more preferably 0.5 to 1 parts by mass per 100 parts by mass of the epoxy resin (A).

Examples of the various additives include a plasticizer, a reactive diluent, a storage stabilizer, an antiaging agent, an antioxidant, a pigment, a dye, a coloring agent, a coupling agent, a leveling agent, a tackifier, a flame retarder, an antistatic agent, a conductivity imparting agent, a lubricant, a slidability imparting agent, an ultraviolet absorber, a surfactant, a disperser, a dispersion stabilizer, an antifoaming agent, a dehydrating agent, a cross-linking agent, an antirust agent, and a solvent.

### Method for Producing Adhesive Composition

The adhesive composition according to the present invention can be produced by mixing the components described above. A mixing method may be a method in which the components are mixed with a disper mixer, a double planetary mixer, a rotation-revolution mixer, a homogenizer, a three-roll mill, a kneading machine, a kneader, or the like.

### Method for Applying Adhesive Composition

A method for applying the adhesive composition according to the present invention may be a method in which the adhesive composition filled in a syringe or the like is applied by a dispenser or a method using a spray gun or a brush. In this step, the application temperature of the adhesive composition is preferably 30 to 60° C. The curing temperature of the adhesive composition is preferably 120 to 220° C. and more preferably 140 to 200° C. The curing time is preferably 20 to 120 minutes, more preferably 30 to 90 minutes, and further preferably 30 to 60 minutes.

### Laminated Body

A laminated body according to the present invention is constituted from a substrate 1, a substrate 2, and an adhesive layer obtained by curing the adhesive composition according to the present invention interposed between the substrate 1 and the substrate 2. Examples of each of the substrate 1 and the substrate 2 include: metals such as iron, aluminum, and steel; fiber-reinforced plastics such as CFRP (carbon fiber-reinforced plastic) and GFRP (glass fiber-reinforced plastic); engineering plastic resins such as PET (polyethylene terephthalate), PBT (polybutylene terephthalate), PC (polycarbonate), PI (polyimide), and PA (polyamide); and glass. The laminated body obtained by bonding using the adhesive composition according to the present invention is excellent in toughness and heat resistance and therefore can be used for, for example, vehicles such as automobiles.

### EXAMPLES

The present invention will specifically be described with reference to the following examples, but the present invention is not limited to the examples. It should be noted that polyesters described as production examples were measured by methods that will be described below, and measured values and measuring items are as follows.

### Composition of Polyester

A produced polyester was dissolved in deuterochroloform and analyzed by 1H-NMR (nuclear magnetic resonance) so as to determine a mole ratio of components.

### Number Average Molecular Weight of Polyester

A sample (polyester) was dissolved in or diluted with tetrahydrofuran so that a sample concentration was about 0.5 mass % and filtered through a polytetrafluoroethylene membrane filter having a pore diameter of 0.5 μm so as to obtain a measurement sample. The measurement sample was subjected to gel permeation chromatography, using tetrahydrofuran as a mobile phase and a differential refractometer as a detector so as to measure a number average molecular weight and a weight average molecular weight. A flow rate was set to 1 mL/min and a column temperature was set to 30° C. As to columns, KF-802, KF-804L, KF-806L manufactured by Showa Denko K.K. were used. As to a molecular weight standard, monodisperse polystyrene was used. It should be noted that when the sample was not dissolved in tetrahydrofuran, N,N-dimethylformamide was used instead of tetrahydrofuran. Low molecular compounds (oligomers and the like) having a number average molecular weight of less than 1000 were omitted without being counted.

### Glass Transition Temperature and Melting Point

In a differential scanning calorimeter “DSC220” manufactured by Seiko Instruments & Electronics Ltd., 5 mg of a measurement sample was placed in an aluminum pan, the aluminum pan was sealed with a cover, held once at 250° C. for 5 minutes, and then quenched with liquid nitrogen, and measurement was then performed as the temperature was increased from −100° C. to 250° C. at a temperature rise rate of 20° C./min. In an endothermic curve obtained in such a process, the temperature at the intersection point between a base line before appearance of an endothermic peak and a tangent line to the curve before reaching the endothermic peak was defined as a glass transition temperature (Tg, unit: ° C.). Further, the maximum peak temperature of heat of fusion was determined as a melting point (Tm, unit: ° C.).

### Acid Value

First, 0.2 g of a sample (polyester) was dissolved in 20 mL of chloroform, and the solution was titrated with a 0.1 N potassium hydroxide ethanol solution with the use of phenolphthalein as an indicator. Then, the number of milligrams of KOH consumed for neutralization was determined from the amount of the solution used for titration and was converted into the amount of KOH per gram of the resin so as to determine an acid value (mgKOH/g).

### Tensile Shear Strength

A substrate (SPCC-SD (Steel Plate Cold Commercial) (1.6 mm×25 mm×100 mm, manufactured by Engineering Test Service Co., Ltd.) degreased with acetone was used as a target of adhesion so as to measure tensile shear strength in accordance with JIS K6850:1999. An adhesive composition was applied to the substrate so that an adhesive layer had a thickness of 0.1 mm and cured at 170° C. for 30 minutes so as to prepare a test specimen. The measurement was performed under conditions of 25° C. and a tensile speed of 10 mm/min.

### Evaluation Criteria

∘: The tensile shear strength is 25 MPa or more.
Δ: The tensile shear strength is 20 MPa or more and less than 25 MPa.
×: The tensile shear strength is less than 20 MPa.

### T-Peel (T-Peel Strength)

A substrate (SPCC-SD (Steel Plate Cold Commercial) (0.5 mm×25 mm×200 mm, manufactured by Engineering Test Service Co., Ltd.) degreased with acetone was used as a target of adhesion so as to measure T-Peel in accordance with JIS K6854-3:1999. An adhesive composition was applied to the substrate so that an adhesive layer had a thickness of 0.1 mm and cured at 170° C. for 30 minutes so as to prepare a test specimen. The measurement was performed under conditions of 25° C. and a tensile speed of 100 mm/min.

### Evaluation Criteria

∘: The T-peel is 150 N/25 mm or more.
Δ: The T-peel is 75 N/25 mm or more and less than 150 N/25 mm.
x: The T-peel is less than 75 N/25 mm.

### Dynamic Viscoelasticity (Tan δ)

Dynamic viscoelasticity was measured by a dynamic viscoelastic analyzer (DVA-220, manufactured by IT Keisoku Seigyo K.K.). An adhesive cured at 170° C. for 30 minutes was cut into a strip, and the dynamic viscoelasticity of the cured coated film was measured at a frequency of 10 Hz and a temperature rise rate of 4° C./min. An inflection point peak in the obtained curve was defined as a tan δ value and used as an index of heat resistance.

### Production Example of Crystalline Polyester (E1)

In a reaction tank equipped with a stirrer, a thermometer, and a condenser for draining, terephthalic acid, isophthalic acid, 1,4-butanediol, and polytetramethylene glycol (average molecular weight 1000) were placed so that a final composition was as follows: terephthalic acid 65 mol %, isophthalic acid 35 mol %, 1,4-butanediol 85 mol %, and polytetramethylene glycol 15 mol %. Then, 0.30 parts by mol of tetrabutyl titanate was added, and an esterification reaction was performed by gradually increasing the temperature to 250° C. while water obtained by distillation was discharged to the outside of the system. After the completion of the esterification reaction, initial polymerization was performed while the pressure was gradually reduced to 10 mmHg, and final polymerization was performed by increasing the temperature to 250° C. until a predetermined torque was achieved at 1 mmHg or less so as to obtain a crystalline polyester (E1). The composition and characteristic values of the thus obtained crystalline polyester (E1) are shown in Table 1. These measurement and evaluation items were measured and evaluated by the methods described above.

### Production Examples of Crystalline Polyesters (E2) to (E8) and Amorphous Polyesters (E′1) and (E′2)

Crystalline polyesters (E2) to (E8) and amorphous polyesters (E′1) and (E′2) were produced in the same manner as in the production example of the crystalline polyester (E1) except that the types and amounts of raw materials were changed so that the polyesters had final compositions shown in Table 1. It should be noted that the crystalline polyesters (E3) to (E5) and the amorphous polyesters (E′1) and (E′2) were produced by adjusting a reaction time until a predetermined torque was achieved so that each of the polyesters had a number average molecular weight shown in Table 1. The polyesters (E′1) and (E′2) produced here were confirmed to be amorphous because a melting peak was not observed by measurement using a differential scanning calorimeter.

TABLE 1

| item | component | material name | E1 | E2 | E3 | E4 | E5 | E6 | E7 | E8 |
|---|---|---|---|---|---|---|---|---|---|---|
| composition | polycarboxylic | terephthalic acid | 65 | 100 | | | | 99 | 70 | 100 |
| (mol %) | acid | isophthalic acid | 35 | | | | | | 30 | |
| | | naphthalenedicarboxylic | | | 100 | 100 | 100 | | | |
| | | acid | | | | | | | | |
| | | trimellitic anhydride | | | | | | 1 | | |
| | | adipic acid | | | | | | | | |
| | polyol | ethylene glycol | | 75 | | | | | | |
| | | 1,4-butanediol | 85 | | 60 | 60 | 60 | 75 | 90 | |
| | | 3-methyl-1,5- | | | | | | | | 75 |
| | | pentanediol | | | | | | | | |
| | | polytetramethylene | 15 | | | | | | | |
| | | glycol (Mn 1000) | | | | | | | | |
| | | polytetramethylene | | 25 | 40 | 40 | 40 | 25 | 10 | 25 |
| | | glycol (Mn 2000) | | | | | | | | |

| | | | | | | | | | |
|---|---|---|---|---|---|---|---|---|---|
| physical | number average molecular weight | 35000 | 45000 | 27000 | 15000 | 10000 | 25000 | 5200 | 10000 |
| properties | acid value (mgKOH/g) | 2 | 2 | 3 | 3 | 1 | 2 | 3 | 2 |
| | glass transition temperature (° C.) | −70 | −70 | −70 | −70 | −70 | −70 | −65 | −70 |
| | melting point (° C.) | 125 | 180 | 160 | 160 | 160 | 170 | 60 | 25 |

| item | component | material name | E′1 | E′2 |
|---|---|---|---|---|
| composition | polycarboxylic | terephthalic acid | | |
| (mol %) | acid | isophthalic acid | | |
| | | naphthalenedicarboxylic | | |
| | | acid | | |
| | | trimellitic anhydride | | |
| | | adipic acid | 100 | 100 |
| | polyol | ethylene glycol | | |
| | | 1,4-butanediol | | |
| | | 3-methyl-1,5- | 100 | 100 |
| | | pentanediol | | |
| | | polytetramethylene | | |
| | | glycol (Mn 1000) | | |
| | | polytetramethylene | | |
| | | glycol (Mn 2000) | | |

| | | | |
|---|---|---|---|
| physical | number average molecular weight | 15000 | 6000 |
| properties | acid value (mgKOH/g) | 2 | 1 |
| | glass transition temperature (° C.) | −70 | −70 |
| | melting point (° C.) | — | — |

### Example 1

An adhesive composition 1 was obtained by mixing 100 parts by mass of jER-828 as an epoxy resin (A), 59 parts by mass of BPA as a curing agent (B), 3 parts by mass of HX3742 as a curing catalyst (C), 3 parts by mass of R805 as a thixotropic agent (D), and 9 parts by mass of the crystalline polyester (E1) of Production Example as a crystalline polyester (E) with a rotation-revolution mixer. The tensile shear strength, T-Peel, and tan δ of the obtained adhesive composition 1 were measured. The results are shown in Table 2.

### Examples 2 to 14 and Comparative Examples 1 to 3

Adhesive compositions were produced in the same manner as in Example 1 except that the types and amounts of the components thereof were changed as shown in Table 2. The tensile shear strength, T-Peel, and tan δ of the each obtained adhesive composition were measured. The results are shown in Table 2.

TABLE 2

| | | Example | | | | | | |
|---|---|---|---|---|---|---|---|---|
| | | 1 | 2 | 3 | 4 | 5 | 6 | 7 |
| adhesive composition (blending ratio: parts by mass) | | 1 | 2 | 3 | 4 | 5 | 6 | 7 |
| epoxy resin (A) | jER828 | 100 | 100 | 100 | 100 | 100 | 100 | 100 |
| curing agent (B) | BPA | 59 | 59 | 59 | 59 | 59 | 59 | 59 |
| | DICY | | | | | | | |
| curing catalyst (C) | HX3742 | 3 | 3 | 3 | 3 | 3 | 3 | 3 |
| | DCMU | | | | | | | |
| thixotropic agent (D) | R805 | 3 | 3 | 3 | 3 | 3 | 3 | 3 |
| | RY200 | | | | | | | |
| crystalline polyester (E) | E1 | 9 | | | | | | |
| | E2 | | 9 | | | | | |
| | E3 | | | 9 | | | | |
| | E4 | | | | 9 | | | |
| | E5 | | | | | 9 | | |
| | E6 | | | | | | 9 | |
| | E7 | | | | | | | 9 |
| | E8 | | | | | | | |
| amorphous polyester | E′1 | | | | | | | |
| | E′2 | | | | | | | |
| calcium oxide (F) | CML#35 | | | | | | | 3 |
| evaluation criteria | tensile shear strength (MPa) | ∘ | ∘ | ∘ | ∘ | ∘ | ∘ | ∘ |
| | | 33 | 35 | 33 | 35 | 33 | 30 | 30 |
| | T-Peel (N/25 mm) | ∘ | ∘ | ∘ | ∘ | ∘ | ∘ | ∘ |
| | | 155 | 175 | 220 | 240 | 250 | 205 | 235 |
| | tan δ (° C.) | 102 | 102 | 100 | 102 | 104 | 102 | 100 |
| | | Example | | | | | | |
| | | 8 | 9 | 10 | 11 | 12 | 13 | 14 |
| adhesive composition (blending ratio: parts by mass) | | 8 | 9 | 10 | 11 | 12 | 13 | 14 |
| epoxy resin (A) | jER828 | 100 | 100 | 100 | 100 | 100 | 100 | 100 |
| curing agent (B) | BPA | 59 | 59 | 59 | 59 | | | 59 |
| | DICY | | | | | 9.7 | 9.7 | |
| curing catalyst (C) | HX3742 | 3 | 3 | 3 | 3 | | | 3 |
| | DCMU | | | | | 3.5 | 3.5 | |
| thixotropic agent (D) | R805 | 3 | 3 | 3 | 3 | | | 3 |
| | RY200 | | | | | 5.8 | 5.8 | |
| crystalline polyester (E) | E1 | | | | | 13 | | |
| | E2 | | | | | | | |
| | E3 | 4.5 | 19 | 19 | | | 13 | |
| | E4 | | | | | | | |
| | E5 | | | | 19 | | | |
| | E6 | | | | | | | |
| | E7 | | | | | | | |
| | E8 | | | | | | | 19 |
| amorphous polyester | E′1 | | | | | | | |
| | E′2 | | | | | | | |
| calcium oxide (F) | CML#35 | | | 3 | | | | |
| evaluation criteria | tensile shear strength (MPa) | ∘ | ∘ | ∘ | ∘ | ∘ | ∘ | Δ |
| | | 33 | 33 | 35 | 34 | 37 | 37 | 23 |
| | T-Peel (N/25 mm) | Δ | ∘ | ∘ | ∘ | Δ | Δ | Δ |
| | | 110 | 150 | 180 | 210 | 75 | 75 | 95 |
| | tan δ (° C.) | 108 | 94 | 96 | 92 | 134 | 134 | 88 |

| | | Comparative Example | | |
|---|---|---|---|---|
| | | 1 | 2 | 3 |
| adhesive composition (blending ratio: parts by mass) | | 15 | 16 | 17 |
| epoxy resin (A) | jER828 | 100 | 100 | 100 |
| curing agent (B) | BPA | 59 | 59 | |
| | DICY | | | 9.7 |
| curing catalyst (C) | HX3742 | 3 | 3 | |
| | DCMU | | | 3.5 |
| thixotropic agent (D) | R805 | 3 | 3 | |
| | RY200 | | | 5.8 |
| crystalline polyester (E) | E1 | | | |
| | E2 | | | |
| | E3 | | | |
| | E4 | | | |
| | E5 | | | |
| | E6 | | | |
| | E7 | | | |
| | E8 | | | |
| amorphous polyester | E′1 | 19 | | |
| | E′2 | | 19 | |
| calcium oxide (F) | CML#35 | | | |
| evaluation criteria | tensile shear strength (MPa) | Δ | x | Δ |
| | | 22 | 19 | 20 |
| | T-Peel (N/25 mm) | x | x | x |
| | | 60 | 25 | 25 |
| | tan δ (° C.) | 88 | 84 | 145 |

### Raw Materials

Raw materials shown in Table 2 are as follows.
jER-828: Bisphenol A-type epoxy resin, manufactured by Mitsubishi Chemical Corporation
BPA: Bisphenol A, manufactured by Mitsubishi Chemical Corporation
DICY: Dicyandiamide, manufactured by Mitsubishi Chemical Corporation
HX3742: Imidazole adduct-type catalyst, manufactured by Asahi Kasei Corp.
DCMU: 3-(3,4-Dichlorophenyl)-1,1-dimethyl urea
R805: Hydrophobic fumed silica, manufactured by NIPPON AEROSIL CO., LTD.
RY200: Hydrophobic fumed silica, manufactured by NIPPON AEROSIL CO., LTD.
CML #35: Calcium oxide, manufactured by Ohmi Chemical Industry Co., Ltd.

As can be seen from Examples 1 to 14, the adhesive compositions containing the crystalline polyesters according to the present invention have excellent T-peel, i.e., improved toughness and heat resistance as well as excellent tensile shear strength, i.e., excellent adhesiveness.

On the other hand, in Comparative Examples 1 and 2, amorphous polyesters were used instead of crystalline polyesters. In this case, T-peel, i.e., toughness was poor irrespective of the magnitude of the molecular weight. In Comparative Example 3, no polyester resin was added. In this case, toughness was poor.

### INDUSTRIAL APPLICABILITY

The adhesive composition according to the present invention can suitably be used as an adhesive excellent in adhesiveness, toughness, and heat resistance, and is therefore expected to greatly contribute to industry, especially in the field of structural adhesives.

1-7. (canceled)

8. An adhesive composition containing
an epoxy resin (A),
a curing agent (B),
a curing catalyst (C),
a thixotropic agent (D), and
a crystalline polyester (E).

9. The adhesive composition according to claim 8, wherein the crystalline polyester (E) has an ether bond-containing polyol as a copolymerization component.

10. The adhesive composition according to claim 8, wherein the crystalline polyester (E) has a melting point of 20° C. or higher.

11. The adhesive composition according to claim 8, wherein the adhesive composition further contains inorganic particles (F) having moisture absorbency.

12. The adhesive composition according to claim 8, wherein the crystalline polyester (E) is contained in an amount of 1 to 60 parts by mass per 100 parts by mass of the epoxy resin (A).

13. A laminated body having an adhesive layer obtained by curing the adhesive composition according to claim 8.

14. A vehicle having the laminated body according to claim 8.

15. The adhesive composition according to claim 8, wherein the epoxy resin (A) is bisphenol epoxy resin.

16. The adhesive composition according to claim 8, wherein the curing agent (B) is at least one member selected from a group consisting of dicyandiamide, phenol novolacs, and bisphenolic compounds.

17. The adhesive composition according to claim 8, wherein the curing catalyst (C) is at least one member selected from a group consisting of ureas, imidazole adducts, and phosphoruses.

18. The adhesive composition according to claim 8, wherein the curing catalyst (C) is contained in an amount of 0.5 to 20 parts by mass per 100 parts by mass of the epoxy resin (A).

19. The adhesive composition according to claim 8, wherein the thixotropic agent (D) is hydrophobic fumed silica.

20. The adhesive composition according to claim 8, wherein the crystalline polyester (E) is one composed of a polycarboxylic acid component and a polyol component.

21. The adhesive composition according to claim 8, wherein the polycarboxylic acid component constituting the crystalline polyester (E) is one containing 60 mol % to 100 mol % of an aromatic dicarboxylic acid when the entire amount of the polycarboxylic acid component is taken as 100 mol %.

22. The adhesive composition according to claim 8, wherein the polyol component constituting the crystalline polyester (E) is one containing 90 mol % to 100 mol % of a glycol component when the entire amount of the polyol component is taken as 100 mol %.
